(19) United States
(12) Patent Application Publication
(10) Pub. No.: US 2025/0196338 A1
(43) Pub. Date: Jun. 19, 2025

(54) Checking a Predefined Path of a Robot

(71) Applicants: KUKA Deutschland GmbH, Augsburg (DE); KUKA Systems GmbH, Augsburg (DE)

(72) Inventors: Juergen Blume, Friedberg (DE); Ingo Kresse, Augsburg (DE); Pascal Caprano, Augsburg (DE); Marcus Hofmann, Seesen (DE); Fabian Jennrich, Muenchen (DE)

(73) Assignees: KUKA Deutschland GmbH, Augsburg (DE); KUKA Systems GmbH, Augsburg (DE)

(21) Appl. No.: 18/846,925

(22) PCT Filed: Mar. 13, 2023
(86) PCT No.: PCT/EP2023/056358

§ 371 Date: Sep. 13, 2024

(30) Foreign Application Priority Data
Mar. 15, 2022 (DE) 10 2022 202 562.8
Mar. 15, 2022 (DE) 10 2022 202 563.6
Mar. 15, 2022 (DE) 10 2022 202 564.4
Mar. 15, 2022 (DE) 10 2022 202 569.5
Mar. 15, 2022 (DE) 10 2022 202 571.7

(51) Int. Cl. B25J 9/16

(52) U.S. Cl. CPC B25J 9/163; B25J 9/1666; B25J 9/1671; B25J 9/1697

(57) ABSTRACT

A method for checking a predefined path of a robot includes determining or providing a computer-implemented three-dimensional environment model; determining a distance between a computer-implemented model of the robot and the environment model for different portions of the path; and visualizing a virtual representation of the path using a visualization device in an augmented reality for checking the path, wherein, in this visualization, a warning is issued for a portion of the path if the distance determined for this portion falls within a predefined warning range, and an all-clear is issued for a portion of the path if the distance determined for this portion falls within an all-clear range.

### CROSS-REFERENCE TO RELATED APPLICATIONS

This application is a national phase application under 35 U.S.C. § 371 of International Patent Application No. PCT/EP2023/056358, filed Mar. 13, 2023 (pending), which claims the benefit of priority to German Patent Application Nos. DE 10 2022 202 562.8, DE 10 2022 202 563.6, DE 10 2022 202 564.4, DE 10 2022 202 569.5, and DE 10 2022 202 571.7, each filed Mar. 15, 2022; and is related to U.S. patent application Ser. No. ______ (Attorney Docket No. KUKAR-188), U.S. patent application Ser. No. ______ (Attorney Docket No. KUKAR-189), U.S. patent application Ser. No. ______ (Attorney Docket No. KUKAR-192), and U.S. patent application Ser. No. ______ (Attorney Docket No. KUKAR-193), each filed Sep. 13, 2024, the disclosures of which are incorporated by reference herein in their entirety.

### TECHNICAL FIELD

The present invention relates to a method and system for checking a predefined path of a robot, and to a computer program or computer program product for carrying out the method.

### BACKGROUND

Robot paths can be predefined in particular using a simulated environment and/or by teaching, in particular of path points.

For commissioning in particular, it is preferable to check in advance whether a real robot could or would collide with its real environment, which may differ from the simulated environment or the real environment as it was during teaching, when travelling on a predefined path.

### SUMMARY

The object of the present invention is to improve the operation of robots, in particular (by) checking predefined paths.

This object is achieved by a method, a system, or computer program or computer program product for carrying out a method as described herein.

According to one embodiment of the present disclosure, a method for checking a predefined path of a robot (“robot path”) comprises the steps of:
determining or providing a computer-implemented three-dimensional environment model;
determining a convex envelope for at least one portion of the path;
determining an intersection of the convex envelope with the environment model; and
visualizing a virtual representation of the convex envelope of the path using a visualization device in an augmented reality for checking the path, wherein in this visualization a warning is issued for a portion of the path if at least one intersection exists, and for a portion of the path, in particular this portion, an all-clear is (instead) issued if no intersection exists.

In one embodiment, this allows a checking person to reliably and/or quickly check the predefined path for the risk of possible collisions with the real environment. In one embodiment, the path is checked, preferably by the or a checking person, using or on the basis of the visualized virtual representation and the warning and/or all-clear issued; in a further embodiment, one or more portions of the convex envelope of the path for which a warning is issued (in each case) are checked in a (more) specific, in particular in-depth, precise and/or separate manner, in particular for possible collisions of the robot with the environment, and the path, in particular at least this/these portion(s), is/are modified if necessary.

In one embodiment, the robot comprises a robot arm with three or more, preferably at least six, in one embodiment at least seven, joints; in a further embodiment, swivel joints, which connect movable links of the robot to one another and are movable by drives, in particular motors, of the robot, and/or a mobile base, in particular one which can be moved using at least one drive, in particular motor, of the robot. The invention is particularly advantageous for such robots, in particular due to the complex paths it allows for. In one embodiment, a robot-guided tool or workpiece forms a (distal) movable link of the robot within the meaning of the present invention, or the model of the robot (also) comprises a model of a robot-guided tool or workpiece.

In one embodiment, the path is predefined by the program or by a work program and is, in particular, predetermined in a further embodiment using a simulated environment and/or by teaching, in particular of path points.

In one embodiment, the three-dimensional environment model comprises data, in particular permanently or temporarily stored data, which indicate or describe one or more three-dimensional contour(s) or geometry (or geometries) of a real environment of the robot, in particular a robot cell, production or storage hall or similar.

In one embodiment, the model of the robot comprises data, in particular permanently or temporarily stored data, which indicate or describe the three-dimensional contour(s) or geometry (or geometries) of the (real) robot, in particular of one or more of its movable links. As mentioned above, in one embodiment, a robot-guided tool or workpiece forms a (distal) movable link of the robot within the meaning of the present invention, or the model of the robot (also) comprises a model of a robot-guided tool or workpiece.

A portion of the path for which a warning or all-clear is issued can consist of a (path) point or be a (path) point for which an intersection of the convex envelope is determined.

A convex envelope is herein preferably to be understood as the, in particular smallest, convex set comprising at least a part of the robot, in particular at least a part of the one or more of its movable links, in a pose which is or can be associated with at least one path) point. If the portion of the path comprises two or more (path) points, then the convex envelope is preferably to be understood in such a manner that the convex envelope, in particular the smallest convex envelope, comprises at least a part of the robot, in particular at least a part of the one or more of its movable links in the poses associated with the two or more (path) points of the path portion.

In one embodiment, a portion of the path for which a warning or all-clear is issued extends beyond a (path) point on one or both sides or comprises several (path) points; it can be continuous or discrete, in particular a continuous or discrete sequence of points.

In one embodiment, to determine an intersection of the convex envelope with the environment model for a portion comprising a plurality of points, it is determined whether at least a part of the convex envelope and at least a part of the environment model share a common point, a common area and/or jointly occupy a volume and, in a further embodiment, the part of the convex envelope of the portion comprising a plurality of points is colored accordingly. This means that the check can be carried out (more) quickly in one embodiment.

In one embodiment, to determine an intersection for a portion comprising several (path) points, in particular a continuous portion, a minimum distance or the distance to the point nearest to the environment model is determined as the distance of this portion. If the distance in a further embodiment falls within a predetermined and/or predefined range, the portion, in particular the portion of the convex envelope, can be colored accordingly. This means that the check can be carried out (more) precisely in one embodiment.

In a further embodiment, a portion, in particular a portion comprising one or more points, in particular the portion of the path, the portion of the convex envelope and/or the portion of the at least one part or the at least one link of the robot, is colored according to or as a function of the determined distance if the distance is within a predetermined range. This can improve the precision of the check in one embodiment. For example, a portion, in particular a portion comprising a single point or multiple points, is colored red to issue a warning and/or green to issue an all-clear. Similarly, the coloring can also be multi-level and/or otherwise discretized, for example in {red, yellow, green} or similar, in particular with other colors and/or more finely discretized, or change continuously with the relevant, in particular smallest, distance, for example from red for (too) small distances to green for (sufficiently) large distances or similar.

In one embodiment, the method comprises the step of:
detecting data of a real environment of the robot using a detection device which is mobile in one embodiment and portable in a further embodiment, in particular by a person;
wherein the environment model is determined on the basis of this detected data.

In one embodiment, this allows a real environment of the robot to be advantageously taken into account during the check and thus the risk of a collision with it can be checked particularly reliably.

In one embodiment, the detection device is arranged, in a further embodiment integrated or detachably arranged, on the visualization device. In one embodiment, this allows the environment model to be advantageously determined in situ or promptly before visualization, making it particularly up-to-date and thus the check particularly reliable and meaningful.

In one embodiment, the detection device is moved in a translational and/or rotational manner relative to the real environment to detect the data. In one embodiment, this allows a larger region of the environment and/or the environment to be detected (more) precisely, making the check particularly reliable or meaningful.

In one embodiment, the detection device comprises one or more non-contact measuring distance meters, in a further embodiment one or more radar distance meters, one or more ultrasonic distance meters and/or one or more lidar distance meters. This allows the environment model to be detected (more) precisely in one embodiment, making the check particularly reliable and meaningful. Lidar distance meters are particularly advantageous here, as they are compact and measure precisely.

Additionally or alternatively, the detection device comprises one or more cameras, in one embodiment a 3D camera system, which in one embodiment comprises at least two or stereo cameras, a triangulation system, in which at least one light source images a defined pattern onto the environment and at least one camera captures this pattern, preferably from a different angle of view, at least one TOF camera, at least one interferometry camera, at least one light field camera or similar, and/or image evaluation. This allows the environment model to be detected (more) quickly in one embodiment and thus the check can be carried out particularly quickly and/or a larger environment can be taken into account.

Alternatively, or particularly preferably in addition to the determination on the basis of detected data of the real environment, the environment model is determined in one embodiment on the basis of predefined nominal data, in a further embodiment CAD data, of the environment. In one embodiment, by taking such data into account, the environment model can be determined (more) quickly and/or (more) precisely.

In one embodiment, the model of the robot is determined on the basis of predefined nominal data, in a further embodiment on the basis of the predefined path of the robot and/or on the basis of CAD data of the robot, and/or a measurement of the robot. In one embodiment, by taking such data into account, the model of the robot can be determined (more) quickly and/or (more) precisely. In one embodiment, the model of the robot comprises a predefined pose of the robot links relative to one another and/or a reference system fixed to the environment for the different portions, in particular points, of the predefined path, or indicates such a pose. In one embodiment, a pose or position and orientation within the meaning of the present invention comprises a one-, two-or three-dimensional position and/or a one-, two-or three-dimensional orientation. In one embodiment, the determination of the convex envelope is based on discrete or continuous, in particular on interpolated discrete, poses of the robot model; in particular, in a further embodiment, the discrete poses of the robot over time, in particular of a robot model moving with the robot or of a robot model moving independently of the robot, are used to determine a convex envelope over the (path) points of the portion of the path and/or over time.

As explained above, in one embodiment, a robot-guided tool or workpiece forms a movable link of the robot within the meaning of the present invention. Accordingly, in one embodiment, the model of the robot comprises a computer-implemented model of a robot-guided tool or workpiece as a movable link of the robot. In one embodiment, this can advantageously check the risk of a collision of a robot-guided tool or workpiece with the environment, in particular a collision of a convex envelope comprising the convex envelope of the robot-guided tool or workpiece. Accordingly, in one embodiment, the model of the robot is determined on the basis of predefined nominal data, in a further embodiment CAD data, of the tool or workpiece, and/or a measurement of the tool or workpiece.

In one embodiment, the environment model comprises one or more geometry primitives in a predefined relation, in particular spatial position and orientation, to a real environment obstacle, in particular thus to several real environment obstacles, in each case at least one geometry primitive in a predefined relation, in particular spatial position and orientation, to this real environment obstacle. Additionally or alternatively, in one embodiment, the model of the robot comprises one or more geometry primitives in a predefined relation, in particular spatial position and orientation, to a link of the robot, in particular thus to several links of the robot, preferably at least one end effector, in each case at least one geometry primitive in a predefined relation, in particular spatial position and orientation, to this robot link. This means that the existence of an intersection can be determined (more) quickly in one embodiment. In one embodiment, a geometry primitive within the meaning of the present invention is a polyhedron, in particular a prism, in particular a cuboid, or a cylinder, cone, ellipsoid, in particular a sphere, or similar. This allows the existence of an intersection to be determined particularly quickly in one embodiment.

In one embodiment, the environment model is determined using at least one approximation of features, in particular points, detected with the aid of the detection device, particularly preferably a point cloud detected using the detection device, in a further embodiment using one or more grids and/or one or more approximation surfaces, in particular planar approximation surfaces and/or single or multiple curved approximation surfaces, wherein such grids or approximation surfaces are determined in one embodiment by equalization, in particular interpolation or extrapolation, smoothing and/or other fitting functions of points detected by means of the detection device, in particular the environment model may comprise this approximation. Such an approximation can be used to model the environment in one embodiment in a particularly advantageous manner, in particular quickly and/or precisely.

In one embodiment, the environment model is determined on the basis of the robot, in particular using data detected by the robot, in particular by the detection device, and/or on the basis of the model of the robot. In a further embodiment, the robot, which may also be detected during the detection of data from the robot's real environment using the detection device, is at least partially eliminated or masked out. This allows the environment model to be improved in one embodiment.

In one embodiment, the environment model is determined based on a selection of an environment region by a checking person. In a further embodiment, an environment region selected by the checking person is not taken into account by the environment model; in a further embodiment it is not detected using the detection device, and/or only an environment region selected by the checking person is taken into account by the environment model, in a further embodiment only this environment region is detected by the detection device. This allows the environment model to be improved and/or determined (more) quickly in one embodiment.

In one embodiment, the intersection between the convex envelope, in particular the model of the robot, and the environment model for one or more of the different portions of the path is determined in each case based on an intersection between
an imaginary envelope of a selected movable link of the robot, in one embodiment of a robot-guided tool or workpiece comprising the convex envelope,
or
an imaginary envelope of a plurality of, in one embodiment all, movable links of the robot, in one embodiment correspondingly including a robot-guided tool or workpiece comprising or having the convex envelope,
and
an imaginary envelope of the entire environment of the robot described by the environment model or
an imaginary envelope of a selected part of this environment or envelope,
and may in particular be the corresponding intersection.

Such an imaginary envelope is in one embodiment at least partially represented by the model of the robot or environment model; in one embodiment, one or more of the geometry primitives of the robot model and/or one or more of the geometry primitives of the environment model and/or the approximation of points detected using the detection device, by which the environment model is determined or which the environment model comprises, can in particular be formed at least partially by surfaces, corners, edges, nodes, coordinate lines or similar of the geometry primitives or the approximation, in particular of the grid(s) or the approximation surface(s), and/or comprise a predefined, in particular minimum and/or maximum, distance from the robot (link) or a surface of the environment or the environment region and/or a predefined, in particular minimum and/or maximum, distance from the geometry primitive(s), grid(s) or approximation surface(s) or be defined or predefined accordingly. In particular, an imaginary envelope can be continuous or discrete. Thus, for example, the intersection between corners, edges and/or surfaces of a geometry primitive of the robot model and a grid or an approximation surface of the environment model can be used to determine an intersection between the convex envelope based on the imaginary envelope of the model of the robot and the environment model.

By determining the intersection of an imaginary envelope, which is in particular spaced apart from the convex envelope, of a selected moving link of the robot or of a selected partial region of the entire environment of the robot described by the environment model, in one embodiment the determination can be carried out (more) quickly, in particular limited to prima facie relevant regions.

By determining the intersection of an imaginary envelope of several, in one embodiment all, movable links of the robot or the entire environment of the robot described by the environment model, the check can be carried out reliably in one embodiment, and in particular several different collision possibilities can also be taken into account.

In one embodiment, the visualization device is a mobile visualization device which is in particular portable (by a person, preferably with one hand); in one embodiment, it comprises a handheld apparatus, preferably a handheld, tablet, smartphone, laptop or similar, and/or a pair of glasses, in particular a(ugmented) r(eality) or (virtual) r(eality) glasses. This means that, in one embodiment, checking can be carried out in situ or on site and thus improved. In one embodiment, the visualization device is set up (in terms of hardware and/or software) to control the robot or is (also) used for this purpose. This means that commissioning can be carried out quickly and/or safely in one embodiment.

In one embodiment, the (visualized) virtual representation of the convex envelope of the path comprises an, in one embodiment continuous, path of a robot-fixed reference point, preferably an end effector of the robot, and/or a representation of one or more, in particular all, movable links of the robot, in one embodiment by means of or using geometry primitives of the model of the robot. In one embodiment, the representation of the link or links of the robot changes during the visualization according to the predefined path; accordingly, the virtual representation may comprise in particular a virtual simulation of the robot or representation of the movement, in particular by means of the convex envelope, of one or more of its links when travelling on the path.

By visualizing the path, in particular the envelope of the path as a volume of movement along the path, in one embodiment the check can be carried out (more) quickly and/or (more) reliably, in particular a checking person can check or assess the path in a (more) simple, intuitive and/or quick manner. In one embodiment, issuing a warning or all-clear comprises highlighting, preferably coloring and/or illuminating, the corresponding path or path portion in accordance with the existence of an intersection determined for this purpose, wherein the presence or absence of an intersection can be assigned different highlighting, preferably colors or illuminations, for example the color red for the presence of an intersection and the color green for the absence of an intersection, or else the color red for a determined intersection, the color yellow for smaller distances (in particular of the imaginary or convex envelope) in the all-clear range and the color green for larger distances in the all-clear range, or also a color that changes continuously or in several discrete steps with the determined distance of the imaginary or convex envelope from an environment model, and/or path or path portions with intersections and/or distances are depicted illuminated in the warning range and path or path portions with distances, in particular without intersections, are depicted non-illuminated in the all-clear range, or the illumination changes with the distances.

Additionally or alternatively, issuing a warning or all-clear may comprise highlighting, preferably coloring and/or illuminating, the representation of one or more, in particular all, moving links of the robot according to the distance of the imaginary or convex envelope from the environment model determined for the relevant portion, wherein different distances may be assigned different highlights, preferably colors and/or illuminations, such as described above. For example, the representation for or along portions with (too) small distances is colored red and for or along portions with (sufficiently) large distances is colored green, similarly the color of the representation can change continuously or in several discrete steps with the determined distance, and/or the representation for distances in the warning range is depicted illuminated and in the all-clear range is depicted non-illuminated, or their illumination changes with the distances.

By highlighting, in particular coloring and/or illuminating, the path, in one embodiment a checking person can check or assess the path (more) quickly, by highlighting, in particular coloring and/or illuminating, the representation of the robot link(s) in a (more) intuitive and simplified manner and/or their recognizability can be improved.

In one embodiment, a first virtual representation is used for visualizing the imaginary or convex envelope of a portion of the path when the distance determined for that portion is in the warning range or an intersection exists, and a second virtual representation different therefrom is used to visualize that portion of the path when the distance determined for that portion is in the all-clear range or no intersection exists. For example, as explained elsewhere, a first virtual representation comprising a red colored path portion of a robot-fixed reference point, in particular a plurality of robot-fixed reference points, further in particular robot-fixed reference point(s) comprised in the imaginary or convex envelope, may be used for visualizing a portion of the path if the distance determined for that portion is within the warning range, and for visualizing this portion of the path, a second virtual representation different therefrom is used, comprising a green colored path portion of the robot-fixed reference point, in particular several robot-fixed reference points, further in particular robot-fixed reference point(s) comprised in the imaginary or convex envelope, if the distance determined for this portion is in the all-clear range.

In a further embodiment, a first virtual representation is used for visualizing the imaginary or convex envelope of a portion of the path when the distance determined for that portion is in one part of the warning range or an intersection exists, and another first virtual representation is used for visualizing this portion of the path when the distance determined for that portion falls within another part of the warning range, in particular when no intersection exists. Additionally or alternatively, in a further embodiment, a second virtual representation is used for visualizing a portion of the path when the distance determined for that portion is in one part of the all-clear range, and another second virtual representation is used for visualizing that portion of the path when the distance determined for that portion falls within another part of the all-clear range.

For example, a first virtual representation comprising a thick and/or red colored path portion of a robot-fixed reference point can be used for visualizing a portion of the path if the distance determined for this portion is within the warning range, another first virtual representation comprising a thinner and/or orange colored path portion of the reference point can be used if the distance determined for this portion is greater but still within the warning range, a second virtual representation comprising a thick and/or yellow colored path portion of the reference point can be used if the distance determined for this portion falls within the all-clear range, and another second virtual representation comprising a thinner and/or green colored path portion of the reference point can be used if the distance determined for this portion falls within the warning range but is greater. The visualization by means of a robot-fixed reference point, in particular by means of several robot-fixed reference points, further in particular all robot-fixed reference points, can in one embodiment result in the visualization of the convex envelope; in a further embodiment with points spaced apart from the robot-fixed reference points in the normal direction, said visualization can result in the imaginary envelope.

In one embodiment, this allows the imaginary or convex envelope to be visualized in a manner that allows the checking person in particular to check a predefined path (more) quickly.

Furthermore, in a further embodiment, the visualization of the imaginary or the convex envelope may comprise a transparent or semi-transparent representation in the augmented reality. This allows an intersection to be detected (more) quickly in one embodiment, in particular by the checking person.

The colors, lighting or styles, transparency and divisions mentioned above are of course only examples, wherein a plurality of other discretizations and/or warnings or all-clear notifications are possible.

In one embodiment, when visualizing the virtual representation of the imaginary envelope or the convex envelope of the path, one or more parameters of the path are issued; in one embodiment, a velocity and/or at least one parameter, for example a velocity, for at least one portion, in particular point or pose, of the path selected, in particular by a checking person, and/or at least one parameter, for example a velocity, for a portion, in particular point or pose, of the path that is currently or presently travelled on or approached in a simulated manner during visualization.

Additionally or alternatively, when visualizing in one embodiment, a value of the determined distance of the imaginary envelope or the convex envelope from the environment model for at least one portion of the path, in particular a global minimum distance and/or a distance for a portion, in particular point, of the path selected, in particular by a checking person, and/or for a portion, in particular a point approached in a simulated manner, of the path that is currently or presently travelled on in a simulated manner during visualization is issued.

The output of a parameter and/or a distance value is carried out numerically, acoustically and/or symbolically. For example, a direction of travel can be issued by an arrow, a TCP velocity by a corresponding number, a distance value symbolically by a corresponding line, in particular a dimension line with ends symbolized, for example, by arrows, horizontal lines or similar, and/or numerically by a corresponding number. In one embodiment, the output of a parameter can be visualized in a version outside the imaginary envelope or the convex envelope.

In one embodiment, one or more of the above features allows a checking person to check or assess the path (more) quickly and/or (more) reliably.

Depending on the result of the check, the path is modified in one embodiment, in a further embodiment by (input or specifications of) the checking person or automatically. Then a method described here can be carried out again for or with the modified path(s) in order to check this modified path in an analogous manner, wherein in one further embodiment data of the real environment is detected again and the environment model is determined again on the basis of this data, which can advantageously take into account changes in the real environment; in another further embodiment, the previously used environment model is used instead or is provided (again), which can advantageously reduce effort and time requirements.

The invention can be carried out with particular advantage during or for commissioning the robot for travelling on the predefined path, since safety can be increased and/or effort and/or time can be reduced with particular advantage in this case, but it is not limited to this.

According to one embodiment of the present disclosure, a system, in particular in terms of hardware and/or software, in particular in terms of programming, is configured to carry out a method described herein and/or comprises:
means for determining or providing a computer-implemented three-dimensional environment model;
means for determining a convex envelope for at least one portion of the path;
means for determining an intersection of the convex envelope with the environment model, in particular for different portions of the path; and
a visualization device for visualizing a virtual representation of the convex envelope of the path in an augmented reality for checking the path, wherein in this visualization a warning is issued for a portion of the path if at least one intersection exists for this portion of the path, in particular the distance determined for this portion falls within a predefined warning range. Additionally or alternatively, in one embodiment, an all-clear can be issued for a portion of the path for which no intersection exists, in particular if the distance determined for this portion is within a predefined all-clear range.

In one embodiment, the system or its means comprises:
an, in particular mobile, in particular portable, detection device for detecting data of a real environment of the robot and means for determining the environment model on the basis of this detected data, in particular using at least one approximation of points detected by means of the detection device; and/or
at least one non-contact distance meter, in particular at least one lidar, radar or ultrasonic distance meter, and/or at least one camera, in particular a 3D camera system, and/or image evaluation; and/or
means for determining the environment model on the basis of predefined nominal data, in particular CAD data, of the environment and/or on the basis of the robot, in particular data of the robot detected using a detection device, in particular the detection device, and/or on the basis of the model of the robot and/or on the basis of a selection of an environment area by a checking person; and/or
means for determining the model of the robot on the basis of predefined nominal data, in particular the predefined path of the robot and/or CAD data of the robot, and/or a measurement of the robot;
means for determining an intersection of the convex envelope (and/or the imaginary envelope) between the model of the robot and the environment model for at least one of the different portions of the path on the basis of an intersection between an imaginary envelope of a selected movable link of the robot or an imaginary envelope of a plurality of, in particular all, movable links of the robot and an imaginary envelope of the entire environment of the robot described by the environment model or of a selected partial area thereof; and/or
means for using a first virtual representation for visualizing the convex or imaginary envelope of a portion of the path if an intersection exists for this portion, in particular if the distance of the convex envelope or the imaginary envelope determined for this portion falls within the warning range, in particular a part of the warning range, and a second virtual representation different therefrom, if no intersection is determined for this portion, in particular if the distance of the convex envelope or of the imaginary envelope determined for this portion falls within the all-clear range, in particular a part of the all-clear range, in particular a different first virtual representation if the distance determined for this portion falls within a different part of the warning range, and/or a different second virtual representation if the distance determined for this portion falls within a different part of the all-clear range; and/or
means for outputting at least one parameter of the path, in particular a velocity and/or for at least one selected portion of the path and/or for a visualized portion, in particular a point or pose, of the path which is travelled on or approached in a simulated manner during visualization, and/or a value of the determined distance for at least one portion of the path, in particular a global minimum distance and/or a distance for a selected portion of the path and/or for a visualized portion, in particular point or pose, of the path, in particular travelled on or approached in a simulated manner during visualization, in particular numerically, acoustically and/or symbolically during visualization of the virtual representation of the path.

A system and/or a means in the sense of the present disclosure may be designed in hardware and/or in software, and in particular may comprise at least one, in particular digital, processing unit, in particular microprocessor unit (CPU), graphic card (GPU) or the like, which is preferably data-connected or signal-connected to a memory system and/or bus system, and/or one or multiple programs or program modules. The processing unit may be designed to process commands that are implemented as a program stored in a memory system, to detect input signals from a data bus and/or to issue output signals to a data bus. A memory system may comprise one or more, in particular different, storage media, in particular optical, magnetic, solid-state, and/or other non-volatile media. The program may be such that it embodies or is capable of executing the methods described herein, so that the processing unit can execute the steps of such methods and thus, in particular, visualize the virtual representation of the path or issue the warning or all-clear. In one embodiment, a computer program product may comprise, in particular be, an, in particular computer-readable and/or non-volatile, storage medium for storing a program or instructions or with a program stored thereon or with instructions stored thereon. In one embodiment, execution of said program or said instructions by a system or controller, in particular a computer or an arrangement of a plurality of computers, causes the system or controller, in particular the computer(s), to carry out a method described herein or one or more steps thereof, or the program or instructions are configured to do so.

In one embodiment, one or more, in particular all, steps of the method are implemented completely or partially automatically, in particular by the system or its means.

In one embodiment, the system comprises the robot. In one embodiment, the warning range is or is predefined in such a manner that there is or likely is a collision between the robot and the environment, and/or the all-clear range is or is predefined in such a manner that a collision between the robot and the environment becomes impossible or unlikely.

In one embodiment, the method comprises the step of:
travelling on the checked path with the robot.

As a result, the path can be advantageously checked with the real robot in one embodiment, wherein travelling after checking in the augmented reality advantageously increases safety when travelling with the robot.

Accordingly, one embodiment comprises the system or its means:
means of travelling on the checked path with the robot.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the invention.

FIG. 1 schematically depicts a system for checking a predefined path of a robot according to one embodiment of the present disclosure;

FIG. 2 illustrates a convex envelope of a portion of a path of a robot according to one embodiment of the present disclosure; and

FIG. 3 illustrates a method for checking the predefined path of the robot according to one embodiment of the present disclosure.

### DETAILED DESCRIPTION

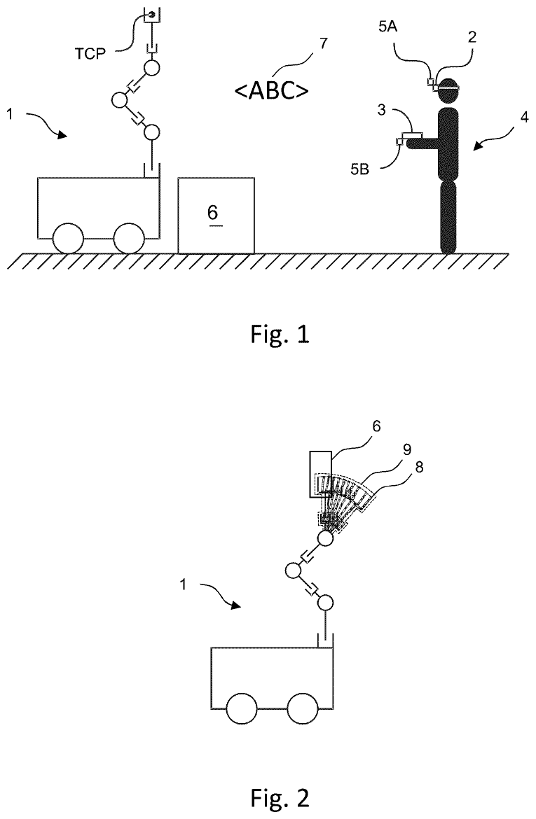

FIG. 1 shows a system for checking a predefined path of a robot 1 using a visualization device in the form of AR glasses 2 or a tablet 3 by a checking person 4.

FIG. 2 shows a robot 1 that carries out a movement with a part of its links that runs along a portion of a predefined path. The movement is depicted discretely in successive poses, which together result in the movement along the portion of the predefined path. The movement is depicted as a convex envelope 8 and an imaginary envelope 9 spaced apart from the convex envelope. Both the convex envelope 8 and the imaginary envelope 9 comprise an intersection with the environment 6. The existence of an intersection can be represented by issuing a warning, in particular a visual warning. Based on the warning, a checking person can, for example, modify the predefined path until a path is found that does not comprise an intersection with the environment 6 and accordingly no warning is issued.

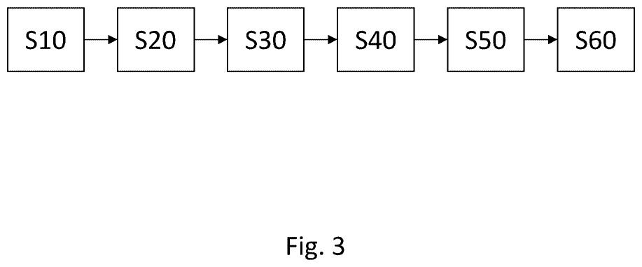

In a step S10 (see FIG. 3), a real environment 6 of the robot is detected using a detection device 5A or 5B, preferably integrated or detachable, arranged on the visualization device 2 or 3, for example a 3D camera system, lidar sensor or similar, and a computer-implemented environment model is determined in a step S20 with the aid of this data. In a modification (not shown), the environment model can additionally or alternatively be created on the basis of nominal data of the environment or only provided, for example retrieved from a storage.

In a step S30, an intersection between a computer-implemented model of the robot and the environment model is determined for different portions, in one embodiment points, of the convex envelope, in particular the imaginary envelope, of the path, wherein the path was predefined, for example, using a simulated environment or by teaching.

For example, the robot model may comprise geometry primitives in the form of cuboids, cylinders or similar, each of which is assigned to one of the moving links of the robot and whose pose or position and orientation changes accordingly in accordance with the relevant portion or path point or during the simulated travelling on the path by the robot. The environment model can comprise, for example, a grid or an approximation surface that approximates a point cloud detected when detecting the real environment. The minimum distance between all these geometry primitives and the grid or approximation surface is then determined as the distance between the robot model and the environment model, for example. The intersection between the robot model and the environment model is then determined, for example, as an overlap between all these geometry primitives and the grid or the approximation surface, or points, in particular volumes, which are simultaneously occupied by the robot model and the environment model.

In a step S40, a virtual representation of the convex envelope of the path is visualized using the visualization device 2 or 3 in an augmented reality for checking the path, for example an envelope around the poses assumed by the robot or its model (over time) during simulated travelling on of the path, wherein the envelope can be or is a convex envelope or wherein the envelope can be or is an imaginary envelope, in particular spaced apart from the convex envelope.

In this visualization, a warning is issued for a portion of the path if an intersection exists for this portion, in particular if the distance determined for this portion between the convex envelope, in particular the imaginary envelope, and the environment model falls within a predefined warning range, and an all-clear is issued for a portion of the path if no intersection exists for this portion, in particular if the distance determined for this portion falls within a predefined all-clear range, for example in the manner described above by means of highlighting corresponding portions or similar.

Using this visualized virtual representation and the warnings or all-clear notifications issued for it, the checking person 4 can check in step S40 whether there is a risk of the robot 1 colliding with the environment when travelling on the predefined path and, if so, how great such a risk is.

In doing so, it can advantageously limit itself to or concentrate on the portions for which a warning is issued and check these more precisely and, if necessary, modify the path in a step S50, in particular in such portions, whereupon steps S30, S40 and, if necessary, S50 can be carried out again.

The checked path can be traveled in one step S60 with the real robot.

Although exemplary embodiments have been explained in the preceding description, it is pointed out that a large number of modifications is possible. It is also pointed out that the exemplary embodiments are merely examples that are not intended to restrict the scope of protection, the applications, and the structure in any way. Rather, the preceding description provides a person skilled in the art with guidelines for implementing at least one exemplary embodiment, with various changes, in particular with regard to the function and arrangement of the described components, being able to be made without departing from the scope of protection as it arises from the claims and from these equivalent combinations of features.

While the present invention has been illustrated by a description of various embodiments, and while these embodiments have been described in considerable detail, it is not intended to restrict or in any way limit the scope of the appended claims to such de-tail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

### LIST OF REFERENCE SIGNS

1 Robot
2 AR glasses
3 Tablet
4 Checking person
5A; 5B Detection device
6 Environment
7 Convex envelope
8 Imaginary envelope
TCP Tool center point

What is claimed is:

1. A method for checking a predefined track of a robot (1), comprising the steps of:
determining (S20) or providing a computer-implemented three-dimensional environment model;
determining (S30) a convex envelope for at least one portion of the track;
determining an intersection of the convex envelope with the environment model; and
visualizing (S40) a virtual representation of the convex envelope of the track using a visualization device (2; 3) in an augmented reality for checking the track, wherein in this visualization a warning is issued for a portion of the track if at least one intersection exists and an all-clear is issued for a portion of the track if no intersection exists for this portion.

2-13. (canceled)
